(19) United States
(12) Patent Application Publication
(10) Pub. No.: US 2003/0179306 A1
(43) Pub. Date: Sep. 25, 2003

(54) Image display remote control device for digital camera or video camera

(75) Inventor: Wen-Chyi Lee, Taipei Hsien (TW)

Correspondence Address: BRUCE H. TROXELL, SUITE 1404, 5205 LEESBURG PIKE, FALLS CHURCH, VA, 22041, US

(73) Assignee: Kinpo Electronics, Inc.

(21) Appl. No.: 10/101,068

(22) Filed: Mar. 20, 2002

(51) Int. Cl. H04N 5/222

(52) U.S. Cl. 348/333.07

(57) ABSTRACT

An image display remote control device for digital camera or video camera of the invention is capably separated from the body of digital camera or video camera. Both said image display remote control device and said body of digital camera or video camera are provided with Bluetooth communication module capably communicated with each other. At a distance, users can directly observe the picture taken by said body of digital camera or video camera from a display screen installed on said image display remote control device. Therefore, Using keys for remote control of said image display remote control device of the invention, the user can also control the focus, diaphragm and shutter of said digital camera or video camera by remote control to adjust the picture taken more delicate and vivid.

### BACKGROUND OF THE INVENTION

1. Field of the Invention

The present invention relates to an image display remote control device for digital camera or video camera, and more particularly to an image display remote control device capably separate from digital camera or video camera and suitable for use as an image display remote control device to control the focus, diaphragm and shutter of a digital camera or a video camera.

2. Description of Related Art

For infrared remote control devices applied to conventional cameras and modern digital cameras or video cameras, in general, are provided with one-way remote control function limited to shorter distance and directional control. A photographer who stands in front to a camera to take a photograph by remote control hardly decide whether the scenery to be taken is correctly located within the photographed scope of camera, and hardly adjust and control the focus, diaphragm and shutter of a camera. Moreover, general digital cameras or video cameras with an image display controller can be in advance displayed those pictures just taken by user, and the user can take a preferable picture by use of the image display controller to properly adjust the amplification rate of lens to the picture displayed. Nevertheless, the image display controller mentioned above is fixed on the body of digital cameras or video cameras, the user once located a far distance to digital cameras or video cameras immediately can not use the image display controller to observe the picture taken by him/her in advance. In addition, general digital cameras or video cameras are also much inconvenient for user when who wants to take a user's picture by himself/herself.

### SUMMARY OF THE INVENTION

The primary objective of this present invention is to provide an image display remote control device capably separated from digital camera or video camera and suitably used to observe the picture in advance taken at a distance from digital cameras or video cameras

The another objective of this present invention is to provide an image display remote control device capably separated from digital camera or video camera and used to adjust and control the focus, diaphragm and shutter of digital camera or video camera by remote control.

### BRIEF DESCRIPTION OF THE DRAWINGS

The invention is description in detail with reference to the following drawings, wherein like numerals represent like elements:

FIG. 1 is an illustrate drawing related to an embodiment of digital camera of the invention.

FIG. 2 is an exploded drawing of an embodiment of digital camera of the invention.

FIG. 3 is a pictorial drawing of image display remote control device for digital camera or video camera of the invention.

FIG. 4 is an exploded drawing of another embodiment of digital video camera of the invention.

### DETAILED DESCRIPTION OF THE PREFERRED EMBODIMENT

Based on the reason that the structure and function of the image display remote control device of the invention, when applied to digital camera or video camera, is substantially the same, therefore, for convenience of illustration, the following text is chosen digital camera as a practical embodiment to illustrate the structure and function of the image display remote control device of the invention, but the meaning of “digital camera” in reality is used to be represented as “digital camera” or “digital video camera”.

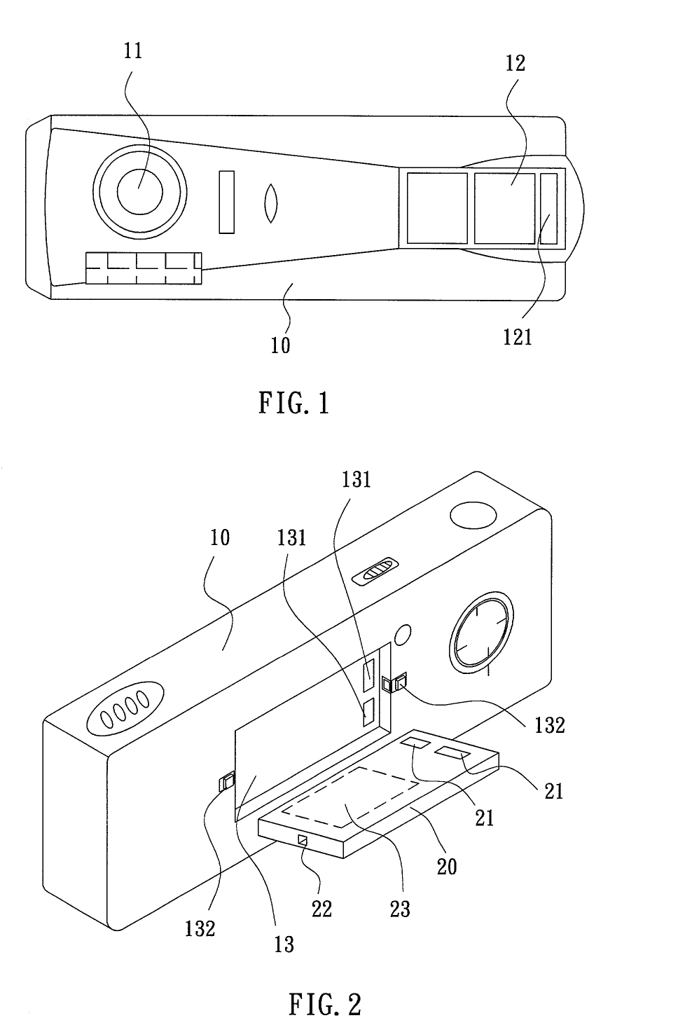

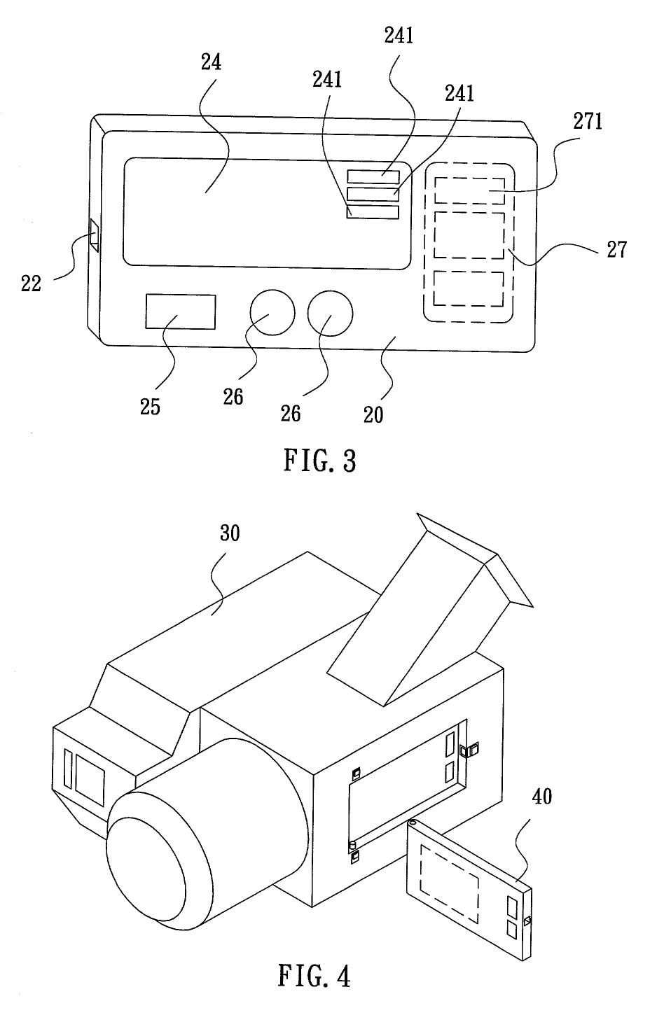

Referring to FIG. 1, FIG. 2, and FIG. 3, the body 10 of an embodiment of digital camera of the invention comprises those basic components such as a lens 11 for general known digital camera. The body of digital camera 10 of the invention is primarily connected with a Bluetooth communication module 12, and which back face of said body of digital camera 10 is provided with a cavity 13 where an image display remote control device 20 (shown as FIG. 2) can be firmly put inside. Said cavity 13 of digital camera 10 has several contacting parts 131 used to contact with relative contacted parts 21 which are arranged on the back face said image display remote control device 20. Once said contacting parts 131 and said contacted parts 21 are properly contacted together, communicated information can be mutually transferred in between said contacting parts 131 and said contacted part 21, in addition, power can be charged into said image display remote control device 20. Said cavity 13 of digital camera 10 also has two retaining clamps 132 arranged on each side of said cavity 13 respectively, which retaining clamps 132 are used to connectedly insert into relative fastening holes 22 formed on each side of said image display remote control device 20 to securely fasten and position said image display remote control device 20 into said cavity 13 of digital camera 10. Which back face of said image display remote control device 20 is installed with battery 23 and which front face is provided with display screen 24, power switch 25, and keys 26 for remote control and which interior of said image display remote control device 20 is also connected with a Bluetooth communication module 27 (shown as FIG. 3).

Making use of technology of Bluetooth communication module which has those characteristics of farther distance and multi-directional communicating capacity, thus said Bluetooth communication module 12 connected within said body of digital camera 10 can be mutually communicated with said Bluetooth communication module 27 connected within said image display remote control device 20 of the invention. When said image display remote control device 20 is taken off from said cavity 13 of digital camera 10 by an user, who can directly switch on power switch 25 and press down keys 26 for remote control to start said Bluetooth communication module 27 of said image display remote control device 20 of the invention. The signal communicated in between antenna 271 of said Bluetooth communication module 27 and antenna 121 of Bluetooth communication module 12 of said body of digital camera 10 is then built, when said Bluetooth communication module 27 is started, and is capably proceeded information mutually communicated in between. The picture taken from the lens 11 of said digital camera 10 is digitized and can be, through Bluetooth communication module 12 communicated with said Bluetooth communication module 24, transferred to and shown on said display screen 24 of said image display remote control device 20. Those data or information about focus, diaphragm and shutter of said digital camera 10 just set up by user to take a picture can be simultaneously displayed on indicating areas 241 of said display screen 24 of said image display remote control device 20. Therefore, using said keys 26 for remote control of said image display remote control device 20, the user can control the focus, diaphragm and shutter of said digital camera 10 by way of remote control to adjust the picture taken by himself/herself, and directly observe the adjusted picture from said display screen 24 and read those controlled data displayed on said indicating areas 241 also.

Accordingly, users, at any location, using said image display remote control device 20 capably separated from said body of digital camera 10 can observe any pictures taken from said digital camera 10. In particular, when users want to take himself/herself picture, said users may intentionally remove himself/herself to a favorite location he/she thought to take an optimal picture for him/her, and may use said keys 26 for remote control of said image display remote control device 20 to control and adjust the focus, diaphragm and shutter of said digital camera 10 to take a much more idealized picture for him/her.

The power source of said image display remote control device 20 of the invention, when separated from said body of digital camera 10 for use, is supplied from said battery 23 installed on whose back face, but supplied from said body of digital camera 10 when said image display remote control device 20 connected to said digital camera as a whole.

The frequency of both Bluetooth communication module 12 and Bluetooth communication module 27 used of the invention is 2.4 GHz for avoiding interference. But, said Bluetooth communication module used of the invention may be substituted by other kind of wireless communication module with the same function of image capably transferred by wireless and remote control.

Referring to FIG. 4, the digital video camera 30 of another embodiment of the invention is connected with an image remote control device 40 capably separated from said digital video camera 30 also. Similarity to digital camera 10 of the invention mentioned above, said digital video camera 30 is provided with Bluetooth communication module, and comprises those basic components such as a lens 11 for general known digital video camera.

The scope of this disclosed invention is not limited to the embodiment illustrated as above. Which scope explained and defined by claims may include all changeable equivalents more particularly only changed in easy amendment or variation.

What is claimed is:

1. An image display remote control device for digital camera or video camera provided with a Bluetooth communication module and a battery is connected to a body of digital camera or video camera which has another Bluetooth communication module, wherein once said image display remote control device separated from said body of digital camera or video camera, said two Bluetooth communication modules are capably communicated mutually to transfer information in between.

2. The image display remote control device for digital camera or video camera as defined by claim 1, wherein on back face of said body of digital camera or video camera is provided with a cavity to capably put said image display remote control device therein.

3. The image display remote control device for digital camera or video camera as defined by claim 2, wherein said cavity has several contacting parts and on back face of said image display remote control device has relative contacted parts corresponding to said contacting parts of said cavity.

4. The image display remote control device for digital camera or video camera as defined by claim 3, wherein said cavity has retaining clamp arranged on each side respectively used to fasten said image display remote control device.

5. The image display remote control device for digital camera or video camera as defined by claim 4, wherein said image display remote control device has relative fastening hole formed on each side corresponding to said retaining clamp of said cavity.

6. The image display remote control device for digital camera or video camera as defined by claim 5, wherein said image display remote control device has display screen, power switch and key for remote control arranged on front face.
